(19) United States
(12) Patent Application Publication
(10) Pub. No.: US 2026/0316137 A1
(43) Pub. Date: Oct. 15, 2026

(54) DEVICE FOR PROCESSING MATERIAL, HAVING AN AT LEAST MANUAL FEEDING AND/OR OPERATING FUNCTION, AND PROGRAMMING SYSTEM

(71) Applicant: TRUMPF Maschinen Austria GmbH & Co. KG., Pasching (AT)

(72) Inventors: Uwe HAIGERMOSER, Altenfelden (AT); Thomas SCHWARZGRUBER, Buchkirchen (AT)

(73) Assignee: TRUMPF Maschinen Austria GmbH & Co. KG., Pasching (AT)

(21) Appl. No.: 19/485,335

(22) PCT Filed: Jun. 20, 2024
(86) PCT No.: PCT/AT2024/060238

§ 371 Date: Nov. 18, 2025

(30) Foreign Application Priority Data
Jun. 22, 2023 (AT) A50489/2023

(51) Int. Cl. B21D 5/00; B23Q 17/24

(52) U.S. Cl. CPC B21D 5/002; B23Q 17/2404

(57) ABSTRACT

A device and a programming system for material machining has at least manual feeding and/or operation. The device has at least one tool and an electronic controller which is configured for selecting and/or positioning tools and for carrying out the machining operation with deformation of the workpiece, as well as with an optical display device, and preferably a device for displaying the correct alignment of the workpiece for the respective machining operation. The controller is configured to determine and display an optimized gripping posture and/or optimized gripping position on the workpiece for each work operation.

The invention relates to a device for material machining with manual feeding and operation, in particular for metallic workpieces, specifically a bending machine, according to the generic term of claim 1, as well as an offline programming system for creating control commands for controlling such devices, according to the generic term of claim 11.

In the case of complex bending parts, it may be unclear in some bending steps how the part will behave during deformation. This can lead to increased danger, especially for untrained operating personnel, as the bending part is then supported in unsuitable positions, including potential crushing points and/or shearing points.

With the help of the applicant's TecZone Bend offline programming system, it is now possible to determine gripper positions for robot-assisted bending cells—here too, possible collisions must be taken into account in the configuration.

EP 2 590 040 B1 describes a bending machine in which two cameras are arranged on the press beam and, in particular, in the area of the working and manipulation space in front of the press beam. These cameras capture the working area in front of the machine, in particular the inserted sheet metal. The captured image is transmitted to a data processing device. This device evaluates the orientation in which the sheet metal was inserted into the bending machine. If the sheet metal is incorrectly oriented for the next bending step to be performed, position correction information is generated and projected onto the sheet metal by a projector, which is also located on the press beam in the front working and manipulation area. This provides the operator with a representation in front of them on the sheet metal showing the direction in which the sheet metal must be moved in order to be correctly inserted into the bending machine for the next work step.

EP 3507034 B1 discloses a bending machine with a bending information display device, which is formed by at least one projector and a display surface for the projected information. Among other things, the bending information can be formed by at least one of the group comprising workpiece contour, bending line, control panel, status data of the press bar, alignment information, target angle, piece counter, and areas on the sheet metal to be formed with an increased risk of injury during the bending process. It is also possible to visualize those areas on the workpiece where there is a risk of injury from the forming sheet metal during the bending process.

The object of the present invention was to overcome the disadvantages of the prior art and to provide a device by means of which the operator can manipulate the workpiece to be processed in a manner that is both low-risk and gentle on the material.

This object is solved by a device and a method according to the claims.

The device according to the invention is equipped with at least one tool and an electronic controller with a memory in which control commands for the tool are stored, as well as an optical display device.

To solve the object, such a device is characterized in that the controller is configured to determine an optimized gripping posture and/or optimized gripping position on the workpiece for each work operation and to output this information to the optical display device.

In the bending view of a prepared bending part, for example, the positions and/or surfaces where the operator can grip the bending part in the respective bending step and guide it safely during the deformation process can be displayed in color. Here, in particular, those gripping positions and/or surfaces at which there is a potential risk to the physical integrity of the operator should be excluded, or those positions and/or surfaces at which this risk is minimal should be displayed.

According to a first advantageous embodiment, a configuration tool for determining the optimal gripping posture and/or optimal gripping position on the workpiece is implemented in the controller, in which the human gripping mechanics is represented.

Preferably, the optimized gripping posture and/or optimized gripping position on the workpiece can be stored in the controller's memory together with bending graphics for each work operation and provided for output on the optical display device.

A further embodiment of the invention provides that the memory of the controller is configured so that the optimized gripping posture and/or optimized gripping position on the workpiece can be stored together with bending graphics for each work operation and provided for output on the optical display device.

A preferred embodiment of the device according to the invention is characterized by a device for reading information from a library which describes the shape changes of the workpiece and the trajectories of different areas of the workpiece during and after the machining operation for workpieces of different initial shapes and for different machining operations.

Preferably, a device for predicting and/or determining the areas of the workpiece with no or minor shape changes and/or short trajectories is also integrated into the device or connected to it.

Preferably, a device according to the invention also has a device for projecting optical markings onto the areas of the workpiece with no or minor shape changes and/or short trajectories.

An alternative embodiment according to the invention is characterized by a device for optically displaying the shape changes of the workpiece and the trajectories of different areas of the workpiece during and after the machining operation.

The optical display can be formed by AR (augmented reality) glasses and/or by a screen.

Another device according to the invention for solving the object set out at the beginning is an offline programming system for creating control commands for controlling devices according to one of the preceding paragraphs. It is equipped with a data input device and an optical display device, as well as a data interface to the device for material machining and/or to a storage medium.

According to the invention, this system is characterized in that the data input device is configured for inputting gripping postures and/or gripping positions on the workpiece.

It is preferable that the data input device and the data interface and/or the storage medium are configured to write the optimized gripping posture and/or optimized gripping position on the workpiece together with bending graphics to the memory of the device and/or to the storage medium for each work operation.

Another advantageous embodiment of the invention is characterized by a configuration tool for the optimal gripping posture and/or optimal gripping position on the workpiece, in which the human gripping mechanics is mapped.

For a better understanding of the invention, it is explained in more detail with reference to the following figures.

Each of the following figures shows a greatly simplified, schematic representation:

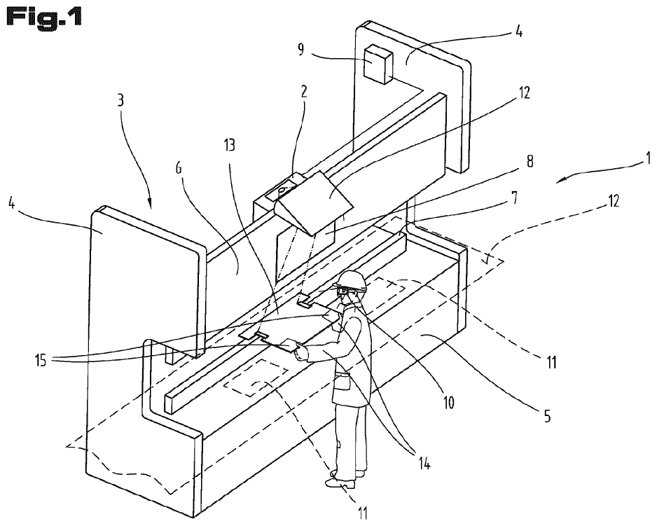

FIG. 1 a simplified perspective view of a bending machine with an optical bending information display device;

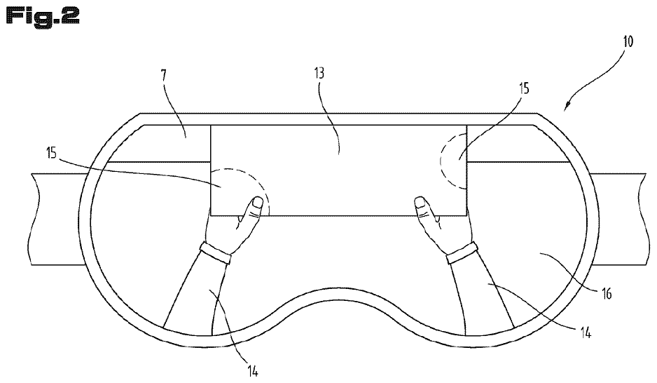

FIG. 2 A view of AR glasses from the user's perspective, for the configuration shown in FIG. 1

First, it should be noted that in the various embodiments described, identical parts are assigned identical reference numerals or identical component designations, whereby the disclosures contained in the entire description can be applied mutatis mutandis to identical parts with identical reference numerals or identical component designations. The positional information chosen in the description, such as above, below, side, etc., also refers to the figure directly described and depicted, and this positional information can be transferred to the new position mutatis mutandis in the event of a change in position.

FIG. 1 shows a bending machine 1 as a preferred example of a device according to the invention for material machining with manual feeding and operation. The bending machine 1 is equipped with a sensor and display unit 2 and at least one tool, here an upper press beam 6, which is movably guided relative to the machine frame 3 with its two side parts 4 and the machine table 5, the relative movement being performed by a drive means not shown. The machine table 5 and a lower tool 7 are arranged below the press beam 6. The movement sequences of the bending machine 1, including the reception of operator inputs and the display of all process-relevant information on a screen 8 as an example of an optical display device, are controlled by an electronic controller 9 with a memory in which control commands for the at least one tool 6, 7 are stored. Another alternative for an optical display device is AR (augmented reality) glasses 10 worn by the machine operator, which receive the information to be displayed from the electrical controller 9 via cable or wireless connection.

Another option for displaying process-relevant information is projection onto preferably reflective and color-neutral display surfaces 11, for example on the machine table 5, for which a projector 12 is attached to the machine frame 3 or the press beam 6. The workpiece 13 itself could also serve as a projection surface as soon as it is in its intended position in the area of the lower tool 7 and/or the press beam 6. Combinations of all projection and optical display variants are also possible.

The controller 9 of the bending machine 1 is now configured in such a way that, either by manually entering the parameters of the workpiece 13, its position and/or the bending sequence, the deformations that occur in the process can be determined in advance, preferably using a simulation algorithm, and, taking these into account, to determine an optimized gripping posture, the optimized positioning of the hands and arms 14 of the operator and/or an optimized gripping position on the workpiece for each work operation and to output this on the optical display device 8, 10, 11, 13. In the bending view of a prepared workpiece 13, for example, those positions and/or areas where the operator can grip the workpiece 13 in the respective bending step and guide it safely during the forming process can be displayed in color.

For this purpose, the controller 9 may include a configuration tool for determining the optimal gripping posture and/or optimal gripping position 15 on the workpiece 13, in which the human gripping mechanics is represented. It is then preferable for each work operation on the bending machine 1, taking into account the specific configuration of the press beam 6 and/or the lower tool 7, the optimized gripping posture and/or optimized gripping position 15 on the workpiece 13 is stored in the memory of the controller 9 together with bending graphics and provided for output on the optical display device 8, 10, 11, 13.

A further embodiment of the invention provides that the memory of the controller is configured so that, for each work operation, the optimized gripping posture and/or optimized gripping position 15 on the workpiece 13 can be stored together with bending graphics and provided for output on the optical display device 8, 10, 11, 13.

FIG. 2 shows a view of AR glasses 10 from the perspective of the wearer of the glasses 10, in particular a view of the display area 16. The objects and machine areas in the field of view are displayed on it in the same way as when looking through conventional safety glasses. This allows the operator of the bending machine 1 to see, for example, the lower tool 7, the machine table 5, and the workpiece 13, as well as his own arms and hands 14. In accordance with the present invention, the information described above, as determined by the controller 9, is superimposed on this image, in particular those positions and/or areas where the operator can grip the workpiece 13 in the respective bending step and guide it safely during the forming process.

A preferred embodiment further comprises a device for reading information from a library which describes the shape changes of the workpiece 13 and the trajectories of different areas of the workpiece 13 during and after the machining operation for workpieces 13 of different initial shapes and for different machining operations, i.e., also taking into account the tools used for this purpose. Advantageously, a device for predicting and/or determining the areas of the workpiece 13 with no or minor shape changes and/or short trajectories can be integrated into or connected to the device, in particular a simulation tool for the respective machining type and sequence.

The display of the optimized gripping position can also be realized by providing a device for projecting optical markings onto the areas of the workpiece 13 with no or minor shape changes and/or short trajectories in or on the bending machine 1. Another alternative is a device for optically displaying the shape changes of the workpiece 13 and the trajectories of different areas of the workpiece 13 during and after the machining operation.

The design of the bending machine 1 described above, or any similarly configured device for material machining, enables the determination and display of optimized gripping positions of the workpiece 13 directly during machining. By using suitable simulation tools, it is also possible to provide the same functionality by means of an offline programming system for creating control commands for the controller 9 of such devices. A corresponding system is equipped with a data input device and an optical display device, as well as a data interface to the device for material machining, for example a bending machine 1 and/or to a storage medium, with which the control commands for any controllers 9 equipped with corresponding interfaces can be provided and imported into them.

The data input device is preferably configured for inputting gripping postures and/or gripping positions on the workpiece. A further embodiment of the invention provides for a configuration of the data input device and the data interface and/or the storage medium which writes the optimized gripping posture and/or optimized gripping position on the workpiece together with bending graphics into the memory of the device and/or onto the storage medium for each work operation. Another advantageous embodiment of the invention is characterized by a configuration tool for the optimal gripping posture and/or optimal gripping position on the workpiece, in which the human gripping mechanics is mapped.

### LIST OF REFERENCE SYMBOLS

1 bending machine
2 sensor and display unit
3 machine frame
4 side part
5 machine table
6 press beam
7 lower tool
8 screen
9 controller
10 AR glasses
11 display area
12 projector
13 workpiece
14 arm and hand
15 gripping position
16 display area

1. A device for material machining with at least manual feeding and/or operation, in particular for machining metallic workpieces (13), specifically a bending machine (1), with at least one tool (5, 6) and an electronic controller (9) which is configured for selecting and/or positioning tools and for carrying out the machining operation with deformation of the workpiece (13), as well as with an optical display device (8, 10, 11, 13), and preferably a device for displaying the correct alignment of the workpiece for the respective machining operation
wherein
the controller (9) is configured for inputting the parameters of the workpiece (13), its position, and/or the bending sequence, and is also configured to determine in advance, for each work operation, the deformations of the workpiece (13) that occur during that operation and an optimized gripping posture and/or an optimized gripping position (15) on the workpiece (13), preferably using a simulation algorithm, and to display the optimized gripping posture and/or an optimized gripping position (15).

2. The device according to claim 1, wherein a configuration tool for determining the optimal gripping posture and/or optimal gripping position (15) on the workpiece (13) is implemented in the controller (9), in which the human gripping mechanics is mapped.

3. The device according to claim 1, wherein for each work operation, the optimized gripping posture and/or optimized gripping position (15) on the workpiece (13) is stored in the memory of the controller (9) together with bending graphics and is provided for output on the optical display device (8, 10, 11, 13).

4. The device according to claim 1, wherein the memory of the controller (9) is configured so that for each work operation, the optimized gripping posture and/or optimized gripping position (15) on the workpiece (13) can be stored together with bending graphics and provided for output on the optical display device (8, 10, 11, 13).

5. The device according to claim 1, further comprising a device for reading information from a library which describes the shape changes of the workpiece (13) and the trajectories of different areas of the workpiece during and after the machining operation for workpieces (13) of different initial shapes and for different machining operations.

6. The device according to claim 5, further comprising a device for predicting and/or determining the areas of the workpiece (13) with no or minor shape changes and/or short trajectories.

7. The device according to claim 6, further comprising a device for projecting optical markings (15) onto the areas of the workpiece (13) with no or minor shape changes and/or short trajectories.

8. The device according to claim 6, further comprising a device (8, 10, 11, 13) for optically displaying the shape changes of the workpiece (13) and the trajectories of different areas of the workpiece during and after the machining operation.

9. The device according to claim 8, wherein the optical display is formed by AR (augmented reality) glasses (10).

10. The device according to claim 8, wherein the optical display is formed by a screen (8).

11. An offline programming system for creating control commands for controlling devices according to claim 1, with a data input device and an optical display device, as well as a data interface to the device for material machining and/or to a storage medium,
wherein
the data input device is configured for inputting gripping postures and/or gripping positions on the workpiece.

12. The programming system according to claim 11, wherein the data input device and the data interface and/or the storage medium are configured to write the optimized gripping posture and/or optimized gripping position on the workpiece together with bending graphics to the memory of the device and/or to the storage medium for each work operation.

13. The programming system according to claim 11, further comprising a configuration tool for the optimal gripping posture and/or optimal gripping position on the workpiece, in which the human gripping mechanics is mapped.
